(19) United States
(12) Patent Application Publication
(10) Pub. No.: US 2004/0140348 A1
(43) Pub. Date: Jul. 22, 2004

(54) Pedometer

(76) Inventor: Wayne G. Fromm, Toronto (CA)

Correspondence Address: John C. Thompson, 69 Grayton Road, Tonawanda, NY, 14150, US

(21) Appl. No.: 10/345,915

(22) Filed: Jan. 16, 2003

(51) Int. Cl. G01C 21/00; G01C 22/00

(52) U.S. Cl. 235/105

(57) ABSTRACT

A simple to use and inexpensive pedometer in which a goal time of walking may be set and which will notify the user when the goal has been reached. The pedometer will include structure for establishing a goal time; apparatus for sensing walking, for summing the time walked, and for comparing the time walked with the goal time; and an alarm device for notifying the user when the goal time has been reached. A countdown display will display the total time remaining to be walked. The structure for establishing the goal time may include a button switch wherein the goal time can be increased in increments. The alarm device may be a vibrator, a speaker, headphones, or a combination of devices. The pedometer may notify the user when the user has been inactive for a period of time so as to motivate the user to get up and get moving, but which will not signal the user when not being worn.

### TECHNICAL FIELD

The present invention relates generally to pedometers, and more particularly to a count-down pedometer wherein a desired goal time of walking may be entered into the pedometer, which pedometer will then notify the user when the goal time has been reached.

### BACKGROUND OF THE INVENTION

Pedometers are well known in the art. Typically pedometers were designed to measure the distance walked. See for example U.S. Pat. No. 1,685,242 and 4,322,609 which disclose mechanical devices. Since the advent of solid state electronics, pedometers have been designed to incorporate additional functions.

U.S. Pat. No. 3,797,010 discloses a jogging computer which has an on/off switch, a selector switch for either walking, jogging, or running, a visual display, an audible signal producing means such as a loud speaker, a control knob to adjust the device so as to accommodate different strides, and a three position switch for causing the display to indicate either distance, elapsed time or accumulated “aerobic” points.

U.S. Pat. No. 4,053,755 discloses an electronic pedometer constructed by a combination of a calculator of the hand-held type and a weighted balance switch closed in response to the strides taken by the user. The stride-actuated switch is connected in parallel with the contact of a function key of the calculator, such as the “add” or “subtract” key. The distance covered by the user in normal stride is entered in a conventional fashion into the calculator by operation of appropriate data entry keys. Then, each time a step is taken by the user, this data is added or subtracted (in accordance with the function selected by the user) to continuously provide an indication of the distance traveled or the distance remaining to be traveled. Alternatively, the calculator may be used to provide a unit count of each step taken and this total then may be multiplied in the calculator by a constant corresponding to the average distance of each step taken by the user.

U.S. Pat. No. 4,371,945 discloses a pedometer including stride measuring devices strapped to both ankles. It further includes an output carried on the wrist of the user.

U.S. Pat. No. 4,510,704 discloses a pedometer incorporated into a shoe. It records each step taken and may be arranged to display, at will, such quantities as total number of steps made, distance walked, mean speed, etc., and may even be associated with pulse rate or blood pressure sensing means whereby these quantities may be displayed.

U.S. Pat. No. 4,855,942 discloses a pedometer/computer which may be programmed to compute and display the number of calories consumed by the user during walking or during an exercise routine. The entire structure may be incorporated into a watch case. This device requires the user to input his/her weight, sex, age, and stride length.

U.S. Pat. No. 5,164,967 discloses a pedometer wherein the appropriate intensity of exercise is set, and wherein the user is permitted to hear the intensity level. This will cause the user to be conscious of whether or not the exercise is being performed at the proper intensity level. The pedometer also counts and displays the number of steps and displays the period of time.

U.S. Pat. No. 6,349,126 discloses a pedometer for summing the number of steps taken during a period of time, e.g., a week, and for displaying the number of steps per time unit, e.g., a day. The purpose of this pedometer is to keep the user interested in exercise.

GB 2,190,773 discloses a pedometer which includes various watch functions. It is also possible to use it as a stop watch. A pendulum device is used to measure the steps taken by the user.

A commercially known pedometer also incorporates an AM/FM radio and ear phones so the user can listen to music while his/her walking distance is being recorded.

Recommendations from experts agree that for better health, physical activity should be performed regularly. The most recent recommendations advise people of all ages to include a minimum of 30 minutes of physical activity of moderate intensity (such as brisk walking) on most, if not all, days of the week. It is also acknowledged that for most people, greater health benefits can be obtained by engaging in physical activity of longer duration.

It has also been suggested that walking can be used as an effective tool to avoid gaining weight. Thus, researchers at the Center for Human Nutrition at the University of Colorado Health Sciences Center have suggested that if one were to walk an additional 15 minutes a day that one would not gain any additional weight, something which would be very desirable as the average adult in the United States gains weight on a yearly basis. Thus, 65% of the U.S. adult population is either overweight or obese, and the average adult gains 1 to 3 pounds a year. Therefore, to stop gaining weight would have significant health benefits. One only needs to know on average how long he/she walks in a given week, and then increase that time by 15 minutes/day.

It has been stated: “Pedometers are practical and accurate tools for measurement and motivation for physical activity.” (Catrine Tudor-Locke, Ph.D., Department of Exercise and Wellness, Arizona State University). Thus, pedometers may be of practical importance in motivating people to get up and get moving.

The President's Council on Fitness and Sports encourages the use of pedometers as a motivational tool, suggesting that the pedometer count steps, so that the user can compare steps walked with a goal. Thus, for example, if the goal is 11,000 steps, at the beginning of a day, one would set the pedometer at “0”, and then check late in the day to see if the desired goal had been achieved. If the goal had not been achieved, then the user would walk further.

The President's Council also suggests goals of 30 minutes to 60 minutes. These goals are easier to comprehend and to accomplish. However, inexpensive and easy to use pedometers, which record the time walked and notify the user when the time of the goal has been achieved, have not been available.

### OBJECTS AND SUMMARY OF THE INVENTION

It is an object of the present invention to provide a simple to use and inexpensive pedometer in which a goal time of walking may be set and which will notify the user when the goal has been reached.

More particularly, it is an object of the present invention to provide a simple to use pedometer designed to advise the user when a desired goal of walking time has been reached; the pedometer including means for sensing walking, means for summing the time walked, means for comparing the time walked with a goal time, and means for notifying the user when the goal time has been reached.

It is an additional object of the present invention to provide a pedometer where the user is notified of a goal of time walked by vibration.

A still further object of the present invention is to provide a pedometer embodiment with a count-down display, such as an LCD readout, so the user will know how much more time should be walked to reach the desired goal.

Yet another object of the present invention is to provide a pedometer which focuses on the time walked, and thus does not require stride adjustments in order to work properly. In this way the user will receive the same health benefits typically attributed to pedometers, but without the complications that other pedometers require which measure distance walked.

Another object of the present invention is to make the pedometer ornamental to encourage use. The body of the pedometer will be designed so that it may be received within different frames to suit the person wearing it. Some frame shapes might include heart, square, triangle, tear drop, circle, rectangle, hexagon.

It is a further object of the present invention to provide a pedometer of the type set forth above where the goal time can be increased in increments of, for example, 15 minutes, by merely pressing a button switch.

Yet another object of the present invention is to provide a pedometer wherein the user may wear earphones so that audible signals can be received, without others hearing them, the signals perhaps being in differing languages.

It is another object of the present invention to provide a pedometer embodiment which will notify the user when the user has been inactive for a period of time so as to motivate the user to get up and get moving, but which will not signal the user when not being worn.

It is a further object of the present invention to provide a pedometer embodiment which may be clipped to waist, be worn as a watch, or which may be worn as a locket.

Another object of the present invention is to provide a pedometer embodiment which may be turned off when carried by the user so that when the user is not walking false walking signals will not be generated, as for example when riding a vehicle.

Another object of the present invention is for some models to include a reflective surface which will provide a measure of safety when walking after dusk and before dawn.

The foregoing objects and other objects and advantages of this invention will be more fully understood after a consideration of the follow detailed description taken in conjunction with the accompanying drawings in which preferred forms of the present invention are illustrated.

### BRIEF DESCRIPTION OF THE DRAWINGS

FIG. 1 illustrates a front view of a first embodiment of the pedometer of this invention.

FIGS. 2 and 3 illustrate rear and side views of the pedometer shown in FIG. 1.

FIG. 4 is a view of the pedometer shown in FIGS. 1-3, this view showing a PC board mounted within the pedometer.

FIG. 5 is a view illustrating a motion sensing mechanism which may be used with the pedometers of this invention.

FIG. 6 illustrates a front view of a second pedometer of the present invention, with its cover being shown in an open position.

FIG. 7 is a side view of the pedometer shown in FIG. 6 showing the cover in full lines in an open position and indicating in dotted lines that the cover can be moved to a closed position.

FIG. 8 is an illustration of a preferred simplified third embodiment of the present invention.

FIG. 9 shows the third embodiment of this invention mounted into a heart shaped frame which may be carried by a lanyard and which may be worn as a locket.

FIG. 10 is a back view of the frame and lanyard shown in FIG. 9.

FIG. 11 is a view of a back belt clasp which may be secured to the back of the frame shown in FIGS. 9 and 10, so that the pedometer of this embodiment may be clipped to a belt or waist band.

FIG. 12 is a block diagram of an electrical circuit which may be used with a fourth embodiment of the pedometer of the present invention.

### DETAILED DESCRIPTION IN GENERAL

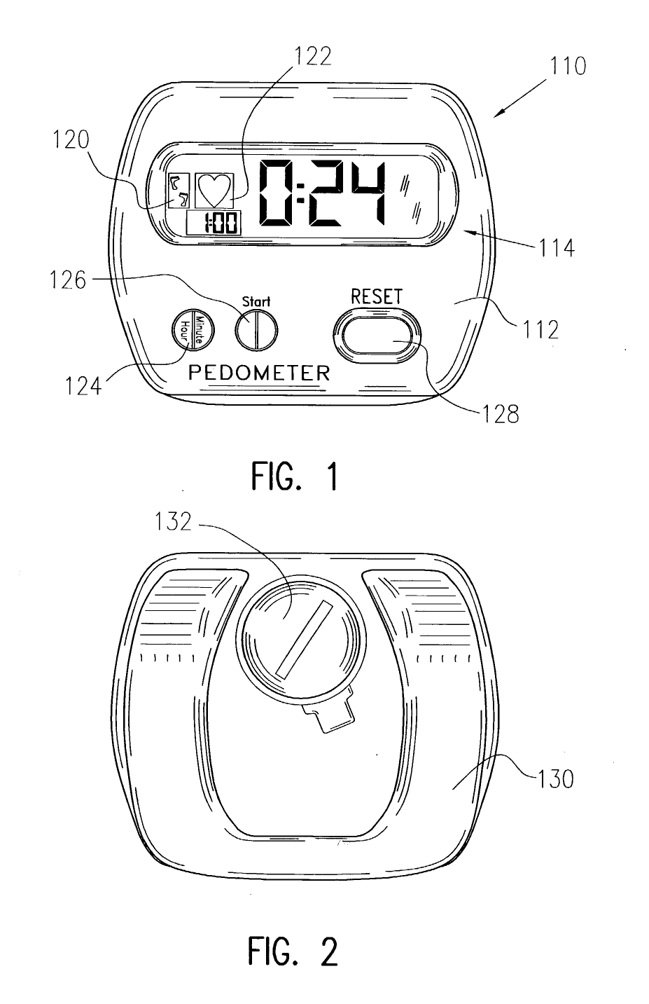

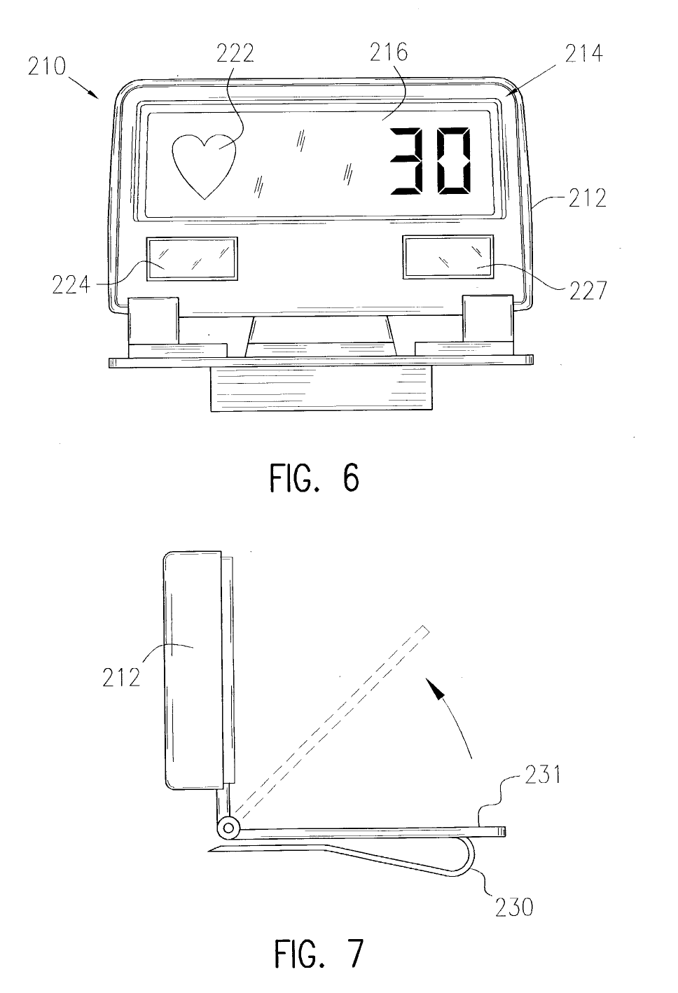

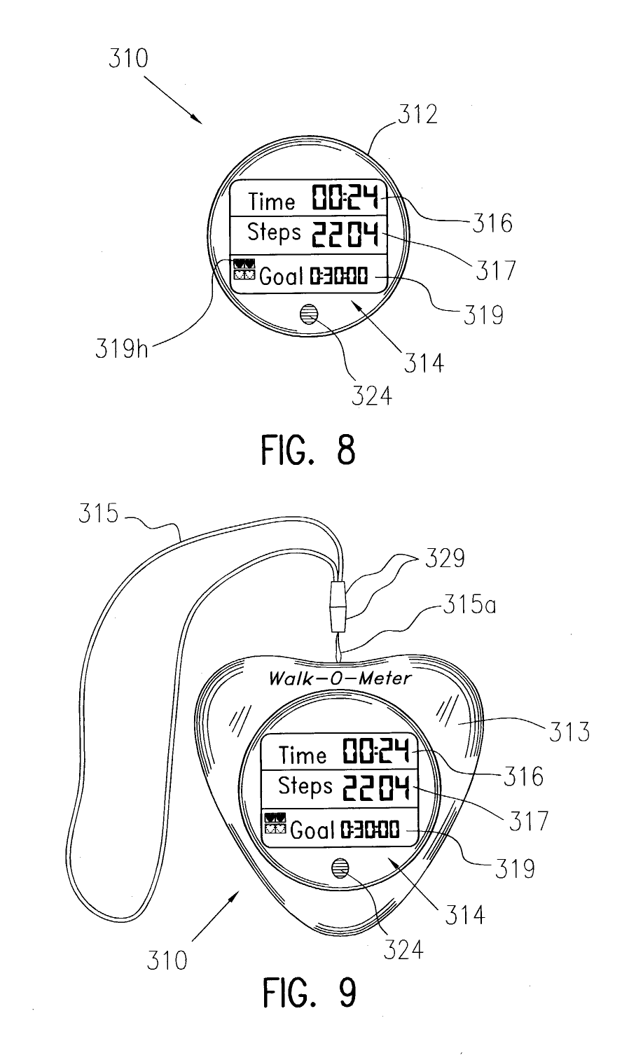

The pedometers of the present invention shown in the various figures are all designed for relatively simple operation and all have a display which will indicate the remaining time to be walked of a goal time. The embodiments shown in FIGS. 1 and 6 are designed to be clipped to a belt or the waistband of pants, shorts or a skirt. The embodiment shown in FIG. 8 is designed to be worn as a locket, but may also be clipped to a belt or waistband. While not shown, it should be appreciated that other shapes may incorporate the principles of this invention, such as for example, a wrist carried pedometer.

### FIRST EMBODIMENT

With reference now to FIGS. 1-4, a first embodiment of the pedometer is indicated generally at 110. This pedometer has a housing 112 on which is mounted an LCD display indicated generally at 114. The LCD display has various portions, portion 116 indicating the remaining time to be walked, portion 118 indicating the goal time, portion 120 indicating whether or not the pedometer is in use, and portion 122 indicating when the goal time has been reached, such as by flashing a heart shaped symbol.

Mounted on the housing is a first button switch 124 which is used to set the goal time. To this end, the button switch is pressed to set incremental increases in time, for example, 15 minutes. Thus, if the button switch 124 on housing 112 is pressed once, the goal time will be increased by 15 minutes, if pressed a second time, the goal time will be increased a further 15 minutes, etc. The housing is further provided with a button switch 126 to turn the pedometer “on” and “off”. The pedometer is additionally provided with a button switch 128 to reset the goal time to zero for the purpose of both initiating operation and setting a new goal time.

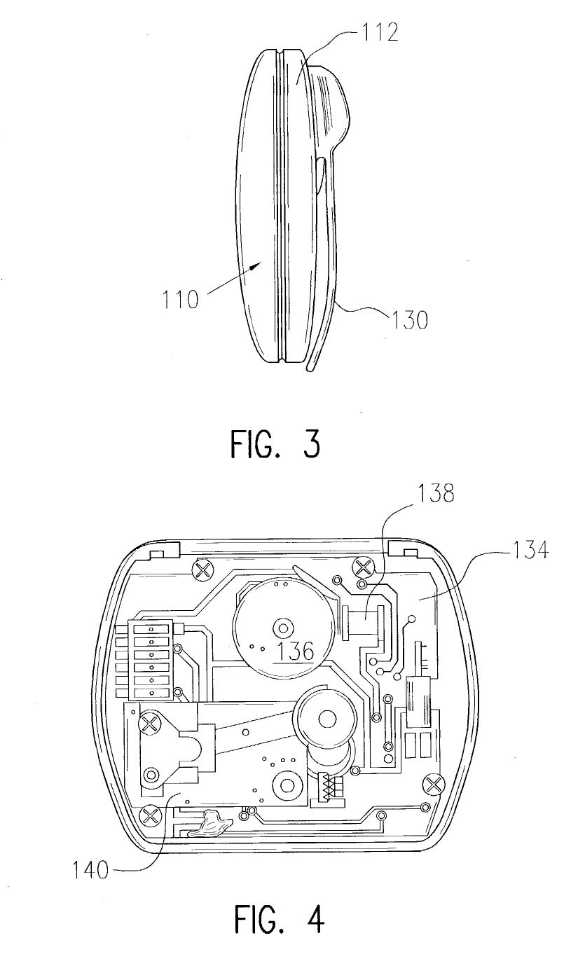

As can be seen from FIGS. 2 and 3, the back of the pedometer is provided with a belt clip 130. As the pedometer will be powered by a battery (not shown), it is necessary to provide a battery cover 132 to hold the battery in place.

Mounted within the pedometer is a printed circuit board 134 which incorporates various electrical components, such as a speaker 136 and a vibrator 138. Also mounted upon the printed circuit board is a central processing unit (or CPU) 140.

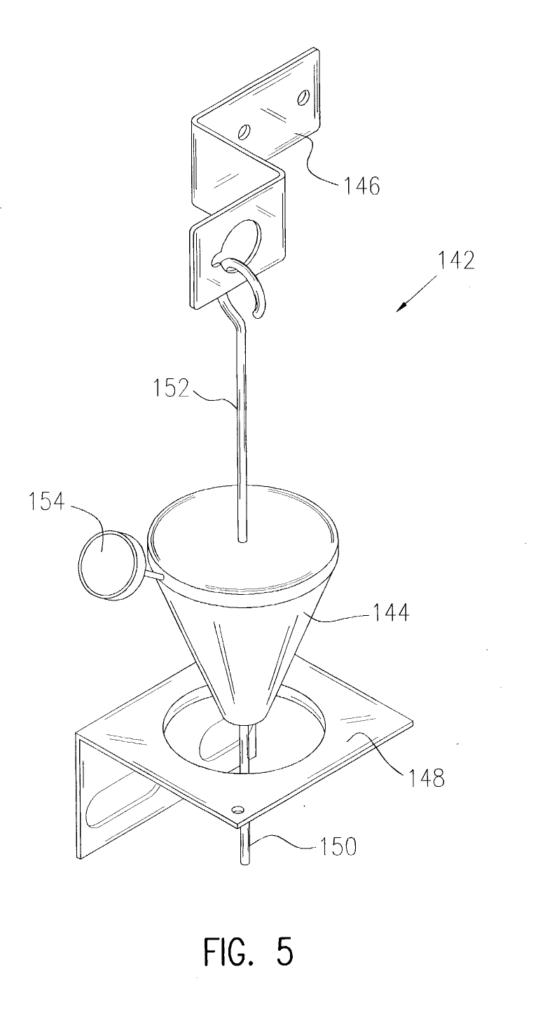

While not shown in FIGS. 1-4, the pedometer includes means for sensing walking in the form of a motion sensor. One form of motion sensor which may be utilized is shown in FIG. 5 and is indicated generally at 142. This form of motion sensor includes a pendulum/plumb bob which is supported by an upper electrically conductive bracket 146. An electrical conductive rod 150 which may be an extension of the plumb bob support rod 152 is adapted to make electrical contact with a lower electrically conductive bracket 148. The terms “upper” and “lower” refer to the position of these components when the pedometer is clipped to a belt or the like. In order to control movement of the pendulum, a dash pot 154 is provided to limit excessive swinging motion.

In operation, the user will clip the pedometer to his or her belt or the waistband of pants, shorts or a skirt. If the user has not yet done so, he or she will set the goal time by pressing the button switch 124. When this occurs, the CPU will store an initial goal time, of for example 15 minutes. Typically, the button switch 124 will be pressed a number of times to advance the goal time incrementally to the desired amount. For example, if the goal to be set is one hour, and the incremental amount is 15 minutes, the button switch will be pressed four times. Thus, it can be seen that the button switch 124 and the CPU 140, working together, are the means for setting the goal time. The user will now commence walking and the motion sensor 142 will sense walking, transmitting a signal to the CPU for every step taken. The first step taken will commence the operation of a count-down clock on the PC board 134, which clock may be incorporated into the CPU. If the user pauses walking, the count-down clock will pause. Thus, the count-down clock acts as means for summing the time walked. The CPU is provided with means for comparing the time walked with the goal time, and is further provided with means for notifying the user when the goal time has been reached, which means include the vibrator 138 and/or the speaker 136.

### SECOND EMBODIMENT

A second embodiment of the present invention is illustrated in FIGS. 6 and 7. The second embodiment is indicated generally at 210 and is provided with a housing 212 and a display indicated generally at 214. In this embodiment, the display has only a count-down portion 216 and a second portion 222 to indicate when the desired walking goal has been achieved. The goal indicator 222 is a heart on the LCD display 214 which will flash when the goal has been achieved. While not shown, this device includes a PC board which carries a CPU. This device also includes a button switch 224 which is used to set the goal time in cooperation with the CPU, which goal time is set by pressing the button switch a selected number of times in the same manner that the goal switch 124 is used in the first embodiment. The second embodiment includes a further button switch 227 which is used to reset the goal time, and also to turn the pedometer “on” and “off”. The pedometer is provided with means to notify the user when the desired goal time has been reached. The notifying means may be either a vibrator or an audible alarm, not shown.

This pedometer is also provided with a belt clip 230 which is carried by a hinged cover 231. When the cover is closed, the display and buttons will be covered.

### THIRD EMBODIMENT

FIGS. 8-11 illustrate a preferred simplified third embodiment of the pedometer of this invention, the third embodiment being indicated generally at 310. This model is intended to be simple to use and inexpensive. While it may be a feature of deluxe models of the pedometer of this invention to include operator adjustable goals, the third embodiment is a simple to use device having a preset goal time. Too many people still don't know how to program their VCR's so the third embodiment is designed to be simple to use. To keep it simple, some of the functions have been automated. Thus, in this embodiment, the pedometer will have a simple one touch operation. The user simply presses a button once to start the goal time running. Once started the pedometer of this invention will count the number of steps walked and measure the time walked and display the number of steps walked and will also display the time walked, or remaining time to be walked. To reset the numbers (steps and time walked) to zeroes the same button will be held in for 3-5 seconds. The preset goal of 30 minutes will be pre-programmed into the device. This is not adjustable by the consumer, however, each and every 30 minutes of walking time measured will trigger an alarm (beeping and/or vibration and/or voice) to notify the user that 30 minutes of walking has been achieved. While the pedometer will count steps walked, it will not have a preset goal for steps. In addition, unlike pedometers which measure the distance walked, there is no stride adjustment. The only goal will be walking time, typically 30 minutes on the display, and a beep for each and every 30 minutes of walking time. Thus this device will work with a single button to facilitate ease of use.

The pedometer 310 of this third embodiment has a body 312 in the shape of a cylinder, although other shapes may be employed. The body 312 of the pedometer is designed so that it may be received into different decorative frames to suit the person wearing it. In addition, the outer edge of the body of the pedometer may be rubberized to withstand shock, which would also facilitate retention of the body 312 within a frame. Some frame shapes might include the illustrated heart locket frame 313 which may be carried by a chain or lanyard assembly 315, 315a, 329.

The pedometer is provided with a three line display 314 including a goal time count-down portion 316, and a step count portion 317, and a further portion 319 which will indicate how many times the goal time has been achieved. The pedometer is also provided with a button switch 324. This button switch has the dual function of starting the device and resetting the LCD display back to a starting position. It technically will not set the goal time. In this embodiment the goal is programmed into the device, for example, the goal time may be programmed at 30 minutes. The goal countdown portion 316 will display the countdown time to reach the goal time. To add functionality the device may be programmed to alternate the display portion 316 every three seconds between showing the actual time walked and the countdown time to reach the goal.

In use, the wearer will initiate operation by simple pressing the button 324 once to start the goal time running. The preset goal time will be pre-programmed into the device, which goal time in this example is 30 minutes. This goal time is not adjustable by the wearer, however, each and every 30 minutes of walking time measured will trigger an alarm (beeping and/or vibration and/or voice) to notify the wearer that 30 minutes of walking has been achieved. In addition, the device may also give a brief alarm (sound and/or vibration) at shorter intervals, for example 10 minutes. At the conclusion of the goal time display 316 will automatically display a new goal time (30 minutes in this example) and start a new countdown without the wearer having to touch button 324. In addition, each goal of 30 minutes will cause a small image of a heart 319h to appear in the third display 319. As shown in FIG. 8, two hearts have appeared but additional hearts, represented by the broken line hearts, may also appear. As illustrated, there are four hearts, but if desired more hearts may be placed on display 319, for example, 6 or 8, or even more. In this way, the wearer can accumulate walking time and steps without resetting, and still be able to calculate how many times the goal of 30 minutes was achieved. To reset the numbers (steps and time walked) to zeroes the button 324 will be held in for 3-5 seconds.

The area about the display 314 may include a reflective surface 319 which will provide a measure of safety when walking after dusk and before dawn. While not shown, the pedometer is provided with a printed circuit board which carries a CPU, the board being connected to the switch 324 as well as to the display portions 316, 317, and 319. Alarm means will also be carried by the device. The alarm in the preferred embodiment will include both a vibrator and a sound alarm so that even those hard of hearing will be aware when their walking goals have been reached. A battery (also not shown) will provide a suitable current to the board and the alarm(s). Also not shown is the means for sensing walking, which preferably is a motion sensor in the form of a pendulum/plumb bob of the type utilized in the first embodiment. As this form of motion sensor may give false readings when the user is on a bus or riding a horse, instructions will be given to turn the device upside down to “pause” it when riding on a bus or horse, etc. When turned upside down the pendulum will not engage and the meter will not progress.

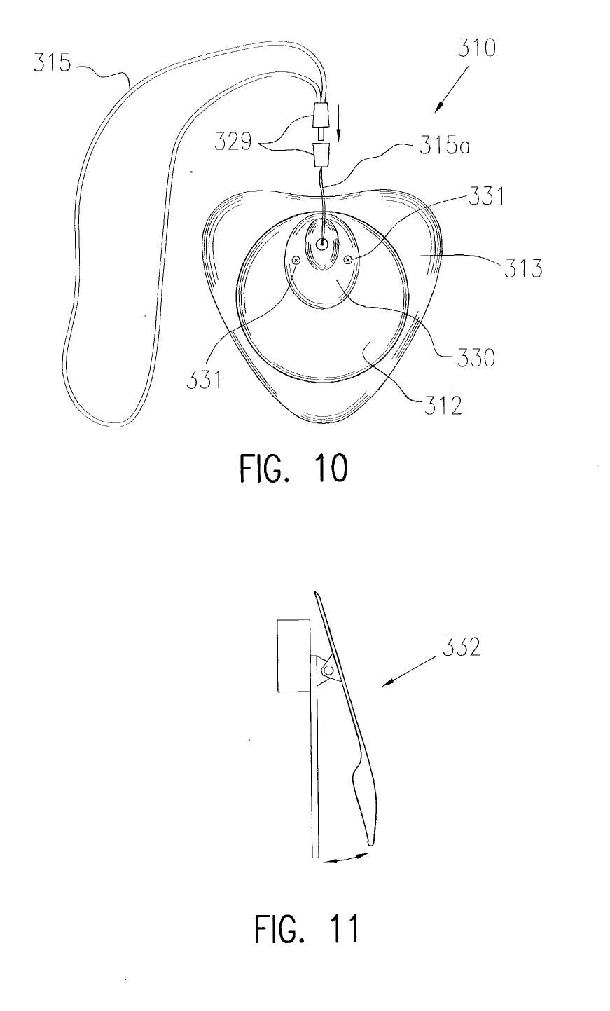

With further reference to FIGS. 10 and 11, it can be seen that the lanyard assembly includes a releasable bayonet connector 329 which secures the portion 315 of the lanyard which is placed about the neck to a lanyard extension 315a. Furthermore, it can be seen that the lanyard extension is carried by a bracket 330 which is releasably secured to the back of the body 312, as for example by screws 331. The bracket 330 may be detached from the body 312 of the pedometer. If this is done, a belt clip 332, of conventional design, may be secured to the back of the body 312 in a conventional manner, as by screws, not shown. This will permit the pedometer and its associated heart shaped locket frame to be worn on a belt or waistband.

### FOURTH EMBODIMENT

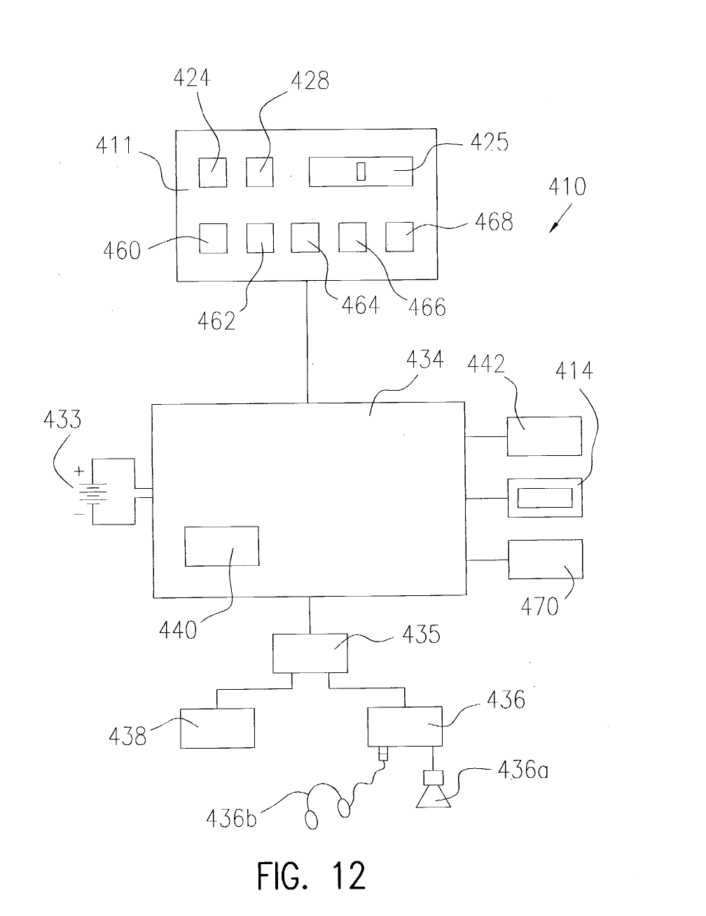

A fourth embodiment of this invention is shown in FIG. 12 and is indicated generally at 410. This embodiment includes many additional features. However, only the electronic components for the fourth embodiment are shown as any suitable housing may be provided. The fourth embodiment 410 includes a display 414 which is similar to the display 114 shown in FIG. 1. A battery 433 provides an electrical source for the various electrical components carried by the PC board 434, the CPU 440, speaker 436, vibrator 438, motion sensor 442, and keypad 411. Thus, the pedometer housing is provided with a keypad 411 which is provided with numerous keys. These keys include a button switch 424 for setting the goal time, a reset button 428 to reset the goal time back to zero, a slide switch 425 to turn the pedometer 410 either “on” or “off” and to further set the sensitivity of motion sensor 442. Other buttons include a button switch 460 for selecting the means 435 for notifying the user when the goal has been reached. Thus, when the button switch 460 is pressed once, there will be a speaker output, when pressed twice, there will be a vibrator output, and when pressed three times, there will be a speaker and vibrator output. The speaker 426 can be either a loud speaker 436a or earphones 436b. When the jack (no number) for the earphones is inserted into the unit, the loud speaker 436a will be turned “off”.

Other button switches include a language selector button 462 which when pressed once will provide an English audio output, when pressed twice will provide a Spanish audio output, when pressed three times will provide another language output, and when pressed additional times will provide further language outputs. The keypad also includes a pause button 464, a mode button 466, and a reminder alert button switch 468. In this connection, the electronic circuit means for reminding the user through the speakers 436 after the user has been inactive for a period of time such as one hour, the reminder alert being for the purpose of motivating the user to get up and be active. Thus, the reminder alert may have an audio message such as, “You have been inactive for one hour. It is time to get up and take a walk.” The button switch 468 is merely a toggle switch which will turn the reminder alert “on” and “off”. The electronics also include a switch 470 which will sense when the pedometer is not being worn. To this end, the housing may be shaped that it is vertical when worn, but horizontal when not worn, the switch 470 being a mercury switch which will either be open or closed when in the vertical position, and the reverse when horizontal.

While preferred forms of this invention have been described above and shown in the accompanying drawings, it should be understood that applicant does not intend to be limited to the particular details described above and illustrated in the accompanying drawings, but intends to be limited only to the scope of the invention as defined by the following claims. For example, while not shown in the accompanying drawings, the pedometer of this invention may take the form of a wrist watch. In addition, while a plumb bob type of motion detector is illustrated, other forms of motion detectors may be employed, such as accelerometers. The term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. A simple to use pedometer designed to advise the user when a desired goal of walking time has been reached; said pedometer comprising:
means for establishing a goal time;
means for sensing walking;
means for summing the time walked;
means for comparing the time walked with the goal time;
means for displaying the remaining time to be walked to achieve the goal time; and
means for notifying the user when the goal time has been reached.

2. The pedometer as set forth in claim 1 wherein the means for notifying the user is a vibrator.

3. The pedometer as set forth in claim 1 wherein the means for notifying the user is an audible sound.

4. The pedometer as set forth in claim 3 wherein the audible sound comes from a speaker which emits a message.

5. The pedometer as set forth in claim 4 further including means to select the language of the speaker.

6. The pedometer as set forth in claim 1 wherein the means for establishing the goal time includes a button switch which may be pressed one or more times to incrementally increase the goal time.

7. The pedometer as set forth in claim 6 wherein holding in the button switch for 3-5 seconds will reset the goal time.

8. The pedometer as set forth in claim 6 wherein pressing the button switch advances the goal time in increments.

9. The pedometer as set forth in claim 1 further including means for displaying the number of steps walked.

10. The pedometer as set forth in claim 1 wherein the means for sensing walking is a plumb bob mechanism.

11. The pedometer as set forth in claim 1 wherein the pedometer further includes a housing.

12. The pedometer as set forth in claim 11 further characterized by the provision of a decorative frame which may be placed about the housing.

13. The pedometer as set forth in claim 12 further characterized by the provision of a lanyard so that the pedometer may be worn about the neck.

14. The pedometer as set forth in claim 1 further including means for reminding the user when the device is worn but there has been no physical activity for a period of time whereby the user is motivated to get up and take a walk.

15. The pedometer as set forth in claim 14 further including a button switch to turn the means for reminding either “on” or “off”.

16. The pedometer as set forth in claim 14 wherein the means for reminding will sense when the pedometer is not being worn, and which will not remind the user when not worn.

17. The pedometer as set forth in claim 14 further including a housing which will be in a vertical position when the pedometer is worn, and which will be in a horizontal position when the pedometer is placed upon a horizontal surface, such as a table top.

18. The pedometer as set forth in claim 1 wherein the pedometer further includes a housing which can be worn about the wrist.

19. The pedometer as set forth in claim 1 wherein the display is further provided with an icon which will flash when the desired goal time is achieved.

20. The pedometer as set forth in claim 1 wherein the timing function may be selectively disabled so that false walking signals will not be stored in memory as for example when the user is riding a horse.
